(19) United States
(12) Patent Application Publication
(10) Pub. No.: US 2025/0021772 A1
(43) Pub. Date: Jan. 16, 2025

(54) TRANSFORMING ONLINE CONVERSATIONS IN A MESSAGING INTERFACE USING LARGE LANGUAGE MACHINE-LEARNED MODELS

(71) Applicant: Maplebear Inc., San Francisco, CA (US)

(72) Inventors: Pak Hong Wong, Vancouver (CA); Shengwen Fang, Vancouver (CA); Tahmid Shahriar, New York, NY (US); Zyshia Williams, Weed, CA (US)

(21) Appl. No.: 18/769,970

(22) Filed: Jul. 11, 2024

Related U.S. Application Data
(60) Provisional application No. 63/526,598, filed on Jul. 13, 2023.

(51) Int. Cl. G06F 40/58; G06F 40/106; G06F 40/166; G06F 40/232

(52) U.S. Cl. CPC G06F 40/58; G06F 40/106; G06F 40/166; G06F 40/232

(57) ABSTRACT

An online system performs a message transformation task in conjunction with the model serving system or the interface system to transform a message input to a chat message. The online system receives the message input in a conversation between a picker and a customer. The online system may transform the message input to a text string that is properly formed and contextually appropriate, format the text string into a chat message, and send the chat message to a receiving party on behalf of the sending party.

### CROSS-REFERENCE TO RELATED APPLICATIONS

This application claims the benefit of U.S. Provisional Application No. 63/526,598, filed Jul. 13, 2023, which is incorporated by reference herein in its entirety.

### BACKGROUND

An online system is an online platform that provides one or more online services. An example of an online service is allowing users to perform transactions associated with items.

The items may represent physical entities stored in a physical location. A user can place an order for purchasing items from participating retailers via the online system, with the shopping being done by a picker. In some instances, the online system uses a communication user interface that allows a user to communicate with a picker that is servicing the user's order. Oftentimes, the picker has limited time to input communicative information properly in the interface, such as typing properly, clear voice to text translation, etc., and sometimes the shopper and user may have a communication gap due to their language differences. This may create undesired delays in fulfilling the user's order.

### SUMMARY

In accordance with one or more aspects of the disclosure, the techniques described herein relate to a method for an online system to perform a message transformation task in conjunction with a model serving system or the interface system to transform a message input to a chat message. The online system receives the message input in a conversation between a picker and a user of an order. The online system transforms the message input to a text string that is contextually appropriate with respect to one or more categories, for example, professionalism and/or customer service, format the text string into a chat message, and sends the chat message to a receiving party on behalf of the sending party.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an example chat interface for presenting chat messages obtained from transformed text strings that are readable to the receiving party of the conversation, according to one or more embodiments.

FIG. 4 is a flowchart for a method of transforming a message input to a text string in a desired language, in accordance with one or more embodiments.

### DETAILED DESCRIPTION

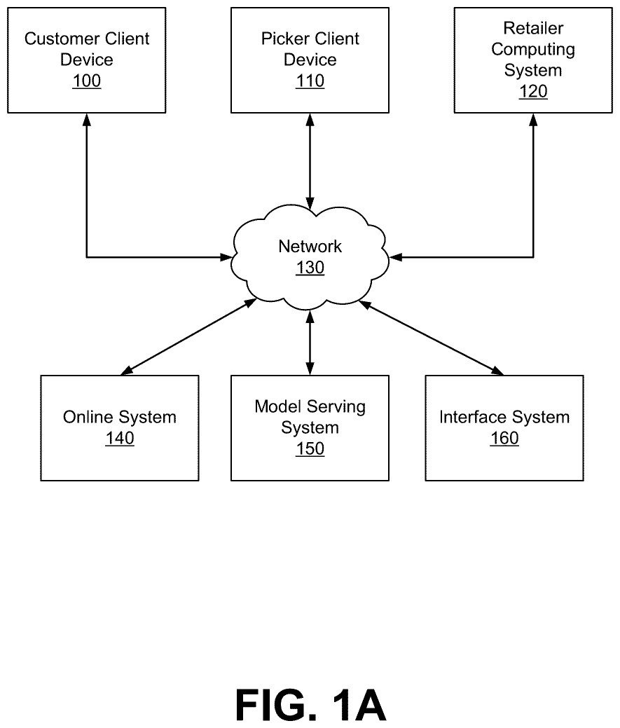

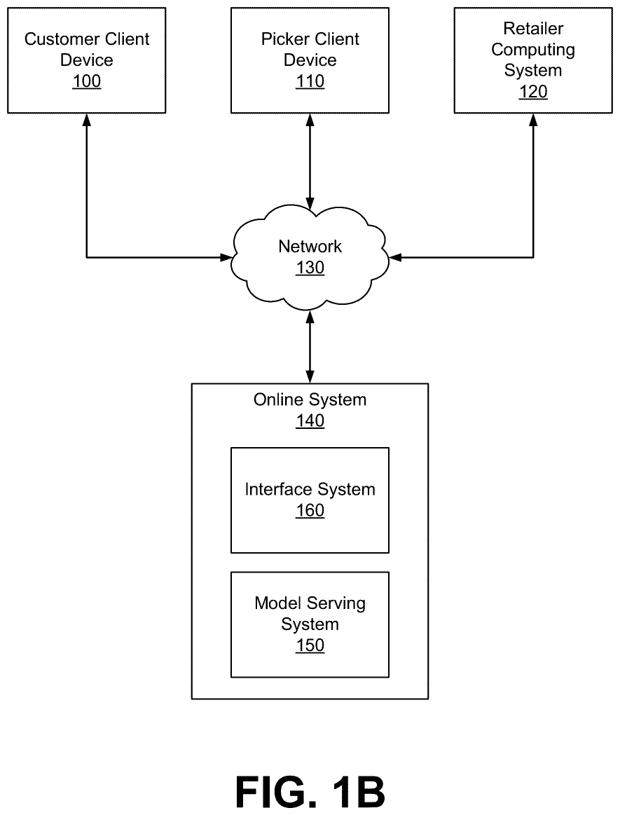

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects the location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a person who collects items for an order from a retailer location and delivers the order to the delivery location for the order. Alternatively, more than one person may serve the role as a picker for an order. As an example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

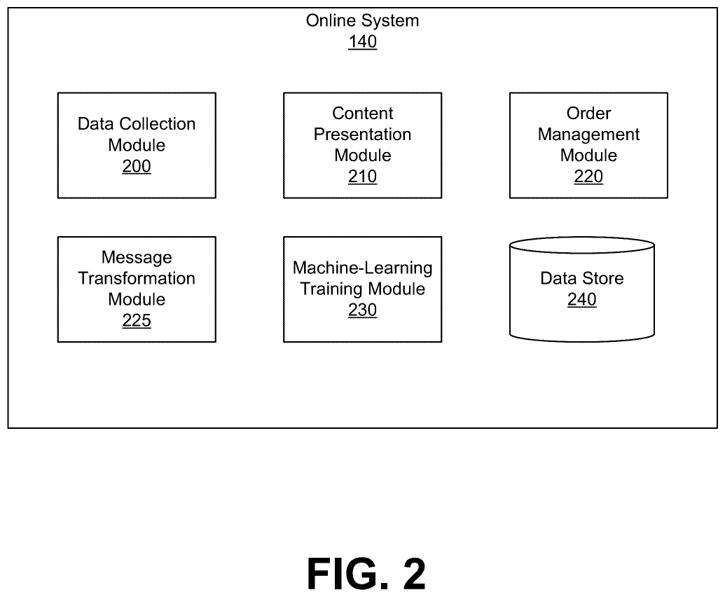

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform language transformation tasks using machine-learned models. The language transformation tasks include, but are not limited to, natural language processing (NLP) tasks, audio processing tasks, image processing tasks, video processing tasks, and the like. In some embodiments, the machine-learned models deployed by the model serving system 150 are models configured to perform one or more NLP tasks. The NLP tasks include, but are not limited to, text generation, query processing, machine translation, chatbot applications, and the like. In some embodiments, the language model is configured as a transformer neural network architecture. Specifically, the transformer model is coupled to receive sequential data tokenized into a sequence of input tokens and generates a sequence of output tokens depending on the language transformation task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In some embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many language transformation tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5trillion parameters.

Since an LLM has significant parameter size and the amount of computational power for training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various language transformation tasks and synthesize and formulate an output based on information extracted from the training data.

In some embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and transform the prompt into a communicative language, e.g., a properly formed and contextually appropriate text string. The prompt may include a message input associated with online orders, such as purchase history of the customer, catalog data, product information, customer preferences, warehouse location, communication history, etc. The LLM transforms the message into a communicative language suitable for the customer based on the knowledge that the LLM was trained on and/or from the contextual information included in the prompt.

In one or more embodiments, the online system 140 performs a language or message transformation task in conjunction with the model serving system 150 and/or the interface system 160 to continuously monitor conversations between a customer and shopper to transform a message input by a sending party to be a contextually appropriate message to send to a receiving party with respect to any potential communication gaps between the sending party and the receiving party.

In one or more embodiments, the message input includes text information, such as, number, symbols, letters, words, phrases, sentences, etc. The message input may include communicative information in different formats, such as emojis, pictures, audios, videos, etc. The online system 140 obtains an output including the transformed language from the model serving system 150 and formulates a chat message to present to a user (e.g., picker or customer). In one or more embodiments, the output may include a text string, including letters, words, phases, sentences, etc. that are appropriate for conversation between a picker and customer. For instance, an example message input by a shopper may include typos, abbreviations, etc.

In one or more embodiments, the online system 140 may receive voice input and use natural language processing/voice-to-text transformation to generate a conversation based on the voice input. The generated voice input may include typos, abbreviations, etc. One example message may be, “hey wassup, inm ur ic shopper 4 2day,” which may not be understood clearly by a user who is not familiar with the abbreviations. The online system 140 constructs a prompt including the message, a task request to the LLM to transform the message input to a contextually appropriate message. The prompt may include other contextual information, such as the current chat history, previous interactions between customers and shoppers, customer use history and preferences, etc. In this example, the generated prompt may be:

“You are a shopper for ABC Co., and you are shopping for groceries, what does “hey wassup, inm ur ic shopper 4 2day” mean?”
or another prompt may be:
“Please appropriately convert and translate this chat from the shopper to the customer.”
The online system 140 may receive a corresponding output from the LLM of the model serving system 140 that recites “Hello. I am your ABC Co. shopper for today.” The online system 140 formats the output as a chat message and sends the chat message to the receiving parties (e.g., users).

In one or more embodiments, the output from the LLM may include a text string in a desired language. A desired language may be associated with parameters, such as, formality, language proficiency, customer preference, cultural understanding. In one or more embodiments, the desired language may refer to a text string that is readable to the receiving party. The LLM may transform the message input by at least modifying one or more parameters so that the output text string is used to formulate a chat message that is appropriate for conversation between a picker and a user. In one or more embodiments, the text string output from the LLM may be determined based on previous chat history across different pickers and users of the online system 140 to infer common conversations. In some implantations, the online system 140 may allow a user to define or modify some of the parameters for the desired language. For instance, the user may select a language, e.g., Spanish, as the default language; and in another example, the user may select a level of proficiency for the desired language.

Specifically, in one or more embodiments, the online system 140 provides the LLM with a collected history of previous chats between pickers and users that provide insight into the communicative language that is appropriate as a chat message between a picker and a user. The online system 140 provides the messages of a conversation such that an agent or component of the model serving system 150 constructs the appropriate prompts to the LLM based on the database of previous chat histories. In other instances, the online system 140 provides the messages of a conversation directly to the model serving system 150 with a generated prompt that includes the message and contextual information about previous chat histories between users and pickers.

In one or more embodiments, the output from the LLM may be determined based on one or more parameters, such as, purchase history of the customer, catalog data, product information, customer preferences, warehouse location, replacement products in the customer's shopping list, and/or any information related to the customer's purchase. In one instance, the contextual information that is submitted with or in addition to the prompt may include customer data, shopper data, retailer store location, or language preferences of the customer or shopper. In another instance, the contextual information may also include communication history of the shopper and of the customer, the purchase history of the customer, catalog data including suggested replacements for items that are in the current customer's cart, which items are most popular at a specific retailer or warehouse location, and the like that allow the LLM to generate an output message that is contextually appropriate for the shopping session and that reduces existing communication gaps between the shopper and the customer. As another example, based on the zone/location of the customer, e.g., Quebec, the LLM may determine that the output language is French since the customer is likely most comfortable with that language given the locale.

In one or more embodiments, the output from the LLM may include suggestions to the picker and/or the user, for example, suggested replacements, suggested brand for a product, etc. The suggestions may be generated by the LLM based on the contextual information. In one or more embodiments, the online system 140 may format a chat message by associating the output from the LLM with one or more actions, such as approved and disapproved. For example, a chat message may include one output, e.g., “Replacing organic strawberries with Brand XXX with strawberries with Brand YYY,” followed by an action button “Approval/Disapproval.” In one or more embodiments, the online system 140 maintains a set of rule actions which are categories of actions that can automatically be invoked in transformation of a message input. For example, the rule actions may include automatically recommending a replacement product for an unavailable product item, generating greeting messages, updating the delivery status, and the like. Responsive to determining that the output from the LLM is associated with an action, the online system 140 may determine whether an appropriate rule action (e.g., add items to an existing order) that corresponds to the action exists. If the rule action exists, the online system 140 invokes the action for the order (e.g., update the delivery status) and incorporates the action in the chat message (e.g., “Get ready to meet! XYZ should be there around 2:15 pm.”) and sends the chat message from the sending party to receiving party. In one implementation, based on the output text string from the LLM, the online system 140 may format a chat message to include image, video, sound, and the like.

As discussed, when a user interacts with a traditional communication user interface, several factors can impact the efficiency and clarity of communication, potentially causing delays in fulfilling the user's order. One issue is the limited time available for input from a user. The user may not have enough time to type their input accurately, leading to typographical errors, incomplete sentences, or unclear information. If a user opts to use voice input, the accuracy of the speech-to-text translation becomes crucial. Poor voice recognition can result in incorrect or unclear text, requiring additional time for the user to correct errors.

Another challenge is communication gaps due to language differences. Language barriers can cause users who are not proficient in the other party's language to misunderstand information, choose incorrect words, and struggle to articulate their needs clearly. Cultural differences can also affect communication clarity, as phrases or idioms common in one language might be confusing or meaningless in another. These issues collectively lead to undesired user experience.

Existing mitigation strategies include improving user interface design with features like autocomplete and suggestions to help users complete their input more quickly and accurately. However, these methods are limited to word-to-word level of interpretation, and fail to take into account the contextual information, such as user preference, culture background, shopping history, etc.

The method described herein uses LLMs to generate contextually appropriate messages that enhance the message input with respect to one or more categories, such as professionalism and customer service, by ensuring consistency, personalization, efficiency, and high-quality communication. The online system 140 transforms a message input by a sending party to be a contextually appropriate message to a receiving party to facilitate communication between the receiving party and the sending party. The online system 140 uses LLM to understand context by analyzing vast amounts of text data from diverse sources, such as conversation history, thus providing relevant and coherent messages, ensuring that communication remains professional and on point. The LLM may personalize responses by analyzing customer data and previous interactions. Additionally, the online system 140 uses LLM to eliminate language barriers, such as typos, slangs, abbreviations, etc., allowing for accurate and efficient communications between pickers and customers.

In one or more embodiments, the language transformation task for the model serving system 150 can primarily be based on reasoning and summarization of knowledge specific to the online system 140, rather than relying on general knowledge encoded in the weights of the machine-learned model of the model serving system 150. Thus, one type of language transformation task may be to perform various types of queries on large amounts of data in an external corpus in conjunction with the machine-learned model of the model serving system 150. For example, the language transformation task may be to perform question-answering, text summarization, text generation, voice to text transformation, language translation, and the like based on information contained in the external corpus.

In one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data and constructs one or more prompts for input to the model serving system 150. A prompt may be generated based on a message input from a picker and context obtained from the structured index of the external data. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a language transformation module 225, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In some embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In some embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The message transformation module 225 retrieves a message input in a conversation occurring between a customer client device 100 and a picker client device 110 and transforms the message input to a text string (or any desired data modality) in a desired language. Specifically, text string is properly formed and contextually appropriate for a conversation between a picker and a customer. In one or more embodiments, the language transformation module 225 continuously monitors and retrieves messages between a picker and a customer from the order management module 220.

The message transformation module 225 constructs a prompt and a task request to the LLM for message transformation. In one or more embodiments, the prompt includes contextual information including customer data, shopper data, retailer store location, or language preferences of the customer or picker. An example prompt to the LLM of the model serving system 150 may be:

“This chat is from ABC Co. Shopper [John Smith] at Warehouse Location [San Francisco, CA]. The items in the customer's order are A1, B2, C3, etc. Based on this information, please appropriately convert and translate this chat from the shopper to the customer in the desired language D1.”
In another example, the contextual information may include communication history of the picker and of the user, the purchase history of the user, catalog data including suggested replacements for items that are in the current user's cart, which items are most popular at a specific retailer or warehouse location, and the like. For example, the message transformation module 225 may construct a prompt that requests that the LLM determines the desired language based on prior chat history, for example:
“Given [current chat history], appropriately convert and translate this chat in the customer desired language.”
The message transformation module 225 may provide the output back to the order management module 220 to format a chat message that can be sent to the receiving party on behalf of the sending party. The content associated with the output (e.g., the desired language) may be obtained from prior chat history where the desired language is used, set, or mentioned.

In one or more embodiments, a message input may include typos, abbreviations, slangs, etc., which is not easy to understand or appropriate in the context by the receiving party. The message transformation module 225 may construct a prompt and request the LLM to perform the transformation based on the message input. The message transformation module 225 may identify an action type associated with transformation of the message input. In identifying the action type, the message transformation module 225 may identify actions including, language translation, typo/abbreviation editing, language touch up, converting lingo or phrases used by one demographic (e.g., particular age group or generation) to an output message that can be understood by a general demographic, etc.

In some cases, the message transformation module 225 may construct a prompt to the LLM based on the identified action type. For example, a message input may be: “I start shopping on stuff. U rdy??” Here, “U rdy” is an abbreviation for “are you ready.” The LLM may identify the abbreviation and the action type is to edit the abbreviation and overall construct a sentence with no or few abbreviations in a way that is understandable by the receiving party. The message transformation module 225 may receive the transformed text string and send it to the order management module 220 to format it as a chat message, e.g., “I am ready to start shopping for your items. Is there anything specific you would like me to prioritize?”

In one or more embodiments, the picker and the user may have different preferred languages. For example, a picker inputs messages in Spanish while the user in the conversation prefers to communicate in English. For example, a picker may input a message, e.g., “No may mas leche de almendras. ?queieres otra csa?” In this case, the LLM may identify that the message input is not in the receiving party's preferred language (e.g., from previous chat histories of the receiving party that was provided as contextual information to LLM), identify that the action type is language translation and transform the message input into the preferred language. The chat message sent to the user on behalf of the picker may be: “Hello! Unfortunately, there is no more almond milk. Would you like me to suggest a replacement?”

In one or more embodiments, the message transformation module 225 applies the LLM to the message input to perform message transformation. The message transformation module 225 may receive an output from the LLM that includes a text string in a desired language. The message transformation may be not limited to correcting typos/abbreviations or translation. In one or more embodiments, the transformation may be associated with parameters of a communicative message, such as, formality, language proficiency, customer preference, cultural understanding, etc. The LLM may transform the message input by at least modifying one or more parameters so that the output text string is used to formulate a chat message that is appropriate for conversation between a picker and a user.

In one or more embodiments, one or more of these parameters may be constantly updated based on new information, e.g., items shopped recently, replacements chosen in recent times, updated catalog data, updated chat history, and the like. In one or more embodiments, the one or more parameters may be constantly updated based on users' feedback. For example, the online system 140 may present a UI element on the client device to allow a user to view and modify the generated message before the user sends the message to the other party in the conversation. The amount of modification performed by the user on the generated message may be used to evaluate the quality of the generated message, such as accuracy, proficiency, etc. For example, if a user deletes a generated message and repeats the original input or slightly modifies the original input, this may indicate that the user is not satisfied with the generated message. On the other hand, if a picker user applies the transformed message or only makes minor revisions to the message, this may indicate the picker user is satisfied with the generated message and is one with positive feedback. In one or more embodiments, response to the generated message from the other party may be also used as feedback to evaluate the quality of the generated message.

In one or more embodiments, the message transformation module 225 further constructs a set of training samples for further fine-tuning weights of the LLM. A training example may include a prompt that was provided to the LLM (e.g., including a message input and contextual information for a previously held conversation) and a transformed output message that is known to be associated with positive feedback (e.g., picker user applies transformed message or makes minor revisions to message). During the fine-tuning process, weights of the LLM are applied to prompts of the training samples to generate one or more estimated outputs. A loss function is calculated indicating a difference between the estimated outputs and the output message of the training samples. The weights are updated by backpropagating terms obtained from the loss function.

As described in conjunction with FIG. 1, in one or more embodiments, the output from the LLM may be determined based on previous chat history across different pickers and users of the online system 140 to infer common conversations. Specifically, in one or more embodiments, the message transformation module 225 may provide the interface system 160 with a collected history of previous communications (e.g., text messages, audio and video calls) between pickers and users obtained from the data collection module 200. The communication information can be used to provide external data or context to the LLM that provides insight into the communicative language that is appropriate as a chat message between a picker and a customer.

In one or more embodiments, for a given conversation between a picker and a customer user, the message transformation module 225 may also provide the model serving system 150 and/or the interface system 160 with a collected history of previous communications of the individual picker or the individual customer. In this manner, the LLM can transform the message input to a chat message that mimics the individual picker's or individual user's prior and future conversations.

In one instance, the message transformation module 225 maintains a set of rule actions which can be invoked in the case that an action is to be performed for a message. Thus, the set of rule actions represents a set of categories of actions that are approved or allowed by administrators of the online system 140 for automatic invocation as an output requested by the sending party. In one instance, the set of rule actions may include, but are not limited to, automatically recommending a replacement product for an unavailable product item, generating greeting messages, updating the delivery status, and the like. In one instance, the set of rule actions maintained by the message transformation module 225 may also be obtained or identified from the previous communications between pickers and users or other appropriate data sources.

Responsive to identifying an action from the output of the LLM, the message transformation module 225 determines whether a rule action for the identified action exists, and invokes the identified action if a corresponding rule action is present for the identified action. The message transformation module 225 may perform the identified action, e.g., recommending a replacement product, and send the output from the LLM and the performed action to the order management module 220 such that a chat message is sent on behalf of the sending party via a communication interface (e.g., chat window, audio or video call). In one or more embodiments, the order management module 220 may format a chat message by associating the output (e.g., one or more text strings) from the message transformation module 225 with one or more actions, such as, “approved” and “disapproved.” In this way, the receiving party may directly respond to the chat message by invoking the one or more actions.

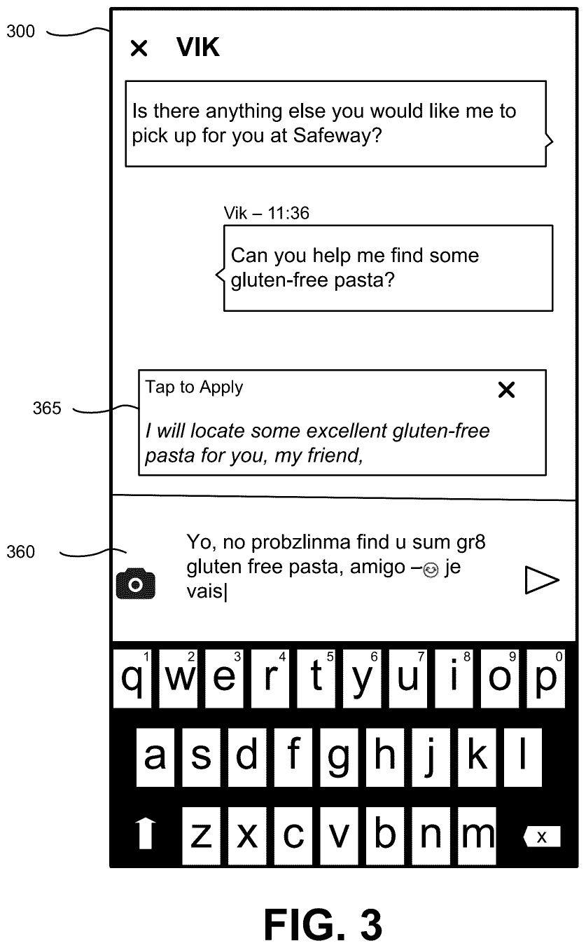

FIG. 3 is an example chat user interface for presenting chat messages obtained from transformed text strings for a receiving party of the conversation, according to some embodiments. As shown in the chat interface 300, a sending party (picker) receives a previous message indicating “Can you help me find some gluten-free pasta?” from a receiving party (e.g., customer). The sending party starts inputting a message in the input field 360 “Yo, no probz! Inma find you sum gr8 gluten free pasta, amigo [emoji] je vais . . . ” that includes abbreviations and lingo of a particular demographic, along with words in a language the receiving party may not understand. In one or more embodiments, the input from the sending party may be of various formats, such as, text input, voice input, images, videos, etc.

The online system 140 obtains the message input and provides the machine-learned language model with a prompt to transform into a more readable form by the receiving party, as described above. For example, the prompt may include the original message, contextual information of the parties, and/or a request to re-write the message using more general phrases and linguistics. While the sending party is inputting the message, the online system 140 provides the prompt to the model serving system 150 and obtains a response, and continuously generates the output in an interface element 365 placed above the input field 360 based on the response. Specifically, the output in the interface element 365 presents the output from the machine-learned model of the model serving system 150 as it becomes available based on the current state of the message input. The output is presented to the user in real time as the chat interface 300 receives the input from the user. In this case, the output indicates “I will locate some excellent gluten-free pasta for you, my friend,” which does not include abbreviations and lingo that is typically understood by a particular generation demographic.

As shown in FIG. 3, an interface element 365 that is an interactable user interface element is generated, e.g., showing as a comment bubble in the chat interface 300. For example, it may include a button which a user may interact (e.g., click, tap, etc.) to apply the text string to generate the message. The interface element 365 may include a button for the user to remove the interface element 365 so that the user may turn off the text transformation/message generation function. When the user taps the interface element 365, the text string presented in the interface element 365 may be applied and presented in the input field 360. The user may review the text string before sending it to the receiving party. In one or more implementations, the user may modify the text string, personalize the text string, and/or add additional information into the text string to generate the message. For example, a user may not need to use the message transformation function for the full message generation. The user may use the generated text string for part of the text message, for example, the user may only need to use the message transformation function for translating a specific term, e.g., a product name. In another example, the user may only need to use the message transformation to add/revise contextual information. A user may integrate part or whole of the text string presented in the interface element 365 to generate the text messages.

In one or more embodiments, the online system 140 may provide a chat interface 300 that integrates action items in the messages. The online system 140 may identify the action items included in the message and embeds links, pictures, interactable elements in the message. For example, the online system 140 may identify the message includes a specific product, and insert a link associated with the product. When a user receives the message and clicks the embedded link, the link will direct the user to a different user interface, web page, etc. for example, providing more information of the product to the user. In another example, the chat interface 300 may present a chat message by associating one or more text strings with one or more actions, such as, “approved” and “disapproved.” The actions may be presented in an interactable user interface, when interacted by the user (e.g., customer clicks on approve button), perform the corresponding actions.

The machine-learning training module 230 trains machine learning models used by the online system 140. For example, the machine-learning training module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters for a machine learning model by “training” the machine learning model. Once trained, the machine learning model uses the set of parameters to transform inputs into outputs.

The machine-learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine-learning training module 230 may apply an iterative process to train a machine learning model whereby the machine-learning training module 230 trains the machine learning model on each of the set of training examples. To train a machine learning model based on a training example, the machine-learning training module 230 applies the machine learning model to the input data in the training example to generate an output. The machine-learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine learning model based on the score generated by the loss function. For example, the machine-learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine-learning training module 230. For example, the data store 240 may store the set of parameters for a trained machine learning model on one or more non-transitory, computer-readable media. The data store 240 uses computer-readable media to store data and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

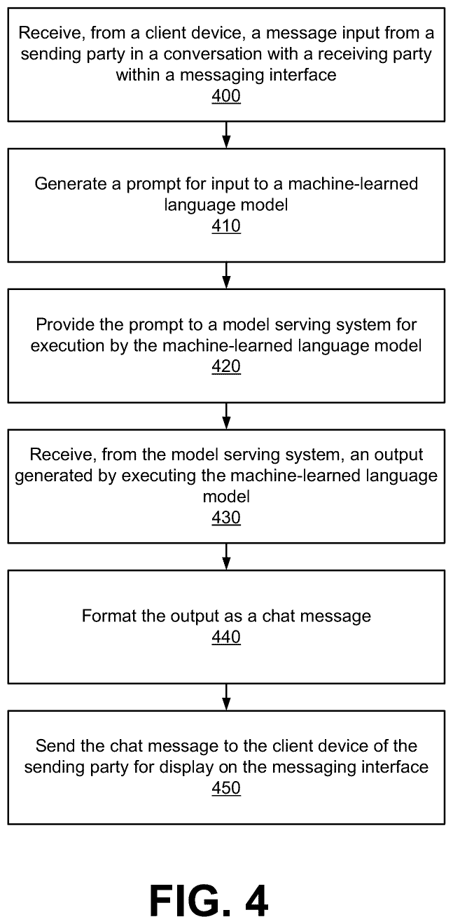

FIG. 4 is a flowchart for a method of transforming a message input to a text string in a desired language, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 receives 400, from one or more client devices, a message input from a sending party in a conversation with a receiving party. The online system 140 generates 410 a prompt for input to a machine-learned language model. The prompt may specify at least the message input and a request to transform the message input into a text string in a desired language. In one or more examples, a text string in a desired language may refer to a text string that is better comprehended to the receiving party. In one or more embodiments, transforming the message input into a text string may include one or more of translating the message input to a different language, converting common abbreviations, correcting misspelled words, or adjusting sentence structure or tone of voice of the message input. The online system 140 provides 420 the prompt to a model serving system 150 for execution by the machine-learned language model for execution. The online system 140 receives 430, from the model serving system, an output generated by executing the machine-learned language model on the prompt, and the output comprises at least the requested text string. The online system 140 formats 440 the output from the model serving system as a chat message. The online system 140 sends 450 the chat message to the client device of the sending party for display on the messaging interface.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a client device, a message input from a sending party during a conversation with a receiving party within a messaging interface;
generating a prompt for input to a machine-learned language model, the prompt specifying at least the message input and a request to transform the message input to a text string for the receiving party;
providing the prompt to a model serving system for execution by the machine-learned language model;
receiving, from the model serving system, an output generated by executing the machine-learned language model on the prompt, the output comprising the requested text string;
formatting the output as a chat message; and
sending the chat message to the client device of the sending party for display on the messaging interface.

2. The method of claim 1, wherein the request to transform the message input comprises a request to perform at least one or a combination of: translating the message input to a different language, converting common abbreviations, correcting misspelled words, or adjusting a sentence structure or tone of voice of the message input.

3. The method of claim 1, further comprising:
providing, to the sending party, the chat message for display in a user interface element of the messaging interface;
receiving, from the sending party, an indication to transmit the chat message; and
responsive to receiving an indication to send the modified chat message, transmitting the chat message to the receiving party.

4. The method of claim 1, further comprising:
providing, to the sending party, the chat message for display in a user interface element of the messaging interface;
receiving, from the sending party, a modification to the chat message; and
responsive to receiving an indication to send the modified chat message, transmitting the modified chat message to the receiving party.

5. The method of claim 1, wherein providing, to the sending party, the chat message for display comprises:
generating the chat message in real time as the message input is received from the sending party.

6. The method of claim 4, wherein the user interface element is located above an input field for inputting the message input within the messaging interface.

7. The method of claim 1, further comprising:
identifying an action item associated with the chat message; and
sending the associated action item to the client device of the sending party for display.

8. The method of claim 1, further comprising:
obtaining feedback from the sending party that the chat message is selected for transmission to the receiving party;
generating a training example including at least the prompt and the chat message; and
fine-turning parameters of the machine-learned language model using the training example.

9. The method of claim 1, wherein the prompt further specifies contextual information associated with the receiving party or the sending party, and wherein the contextual information includes at least one or a combination of: current message history of the conversation, previous instances of conversations between other users, previous instances of conversations between the sending party and the receiving party, or desired language of the receiving party.

10. The method of claim 1, wherein generating the prompt for input to the machine-learned language model comprises:
identifying one or more action types associated with transforming the message input; and
generating the prompt based on the identified one or more action types.

11. A computer program product comprising a non-transitory computer readable storage medium having instructions encoded thereon that, when executed by a processor, cause the processor to perform steps comprising:
receiving, from a client device, a message input from a sending party during a conversation with a receiving party within a messaging interface;
generating a prompt for input to a machine-learned language model, the prompt specifying at least the message input and a request to transform the message input to a text string for the receiving party;
providing the prompt to a model serving system for execution by the machine-learned language model;
receiving, from the model serving system, an output generated by executing the machine-learned language model on the prompt, the output comprising the requested text string;
formatting the output as a chat message; and
sending the chat message to the client device of the sending party for display on the messaging interface.

12. The computer program product of claim 11, wherein the request to transform the message input comprises at least one or a combination of translating the message input to a different language, converting common abbreviations, correcting misspelled words, or adjusting sentence structure or tone of voice of the message input.

13. The computer program product of claim 11, wherein the instructions further cause the processor to perform steps comprising:
providing, to the sending party, the chat message for display in a user interface element of the messaging interface;
receiving, from the sending party, an indication to transmit the chat message; and
responsive to receiving an indication to send the modified chat message, transmitting the chat message to the receiving party.

14. The computer program product of claim 11, wherein the instructions further cause the processor to perform steps comprising:
providing, to the sending party, the chat message for display in a user interface element of the messaging interface;
receiving, from the sending party, a modification to the chat message; and
responsive to receiving an indication to send the modified chat message, transmitting the modified chat message to the receiving party.

15. The computer program product of claim 11, wherein the instructions to provide, to the sending party, the chat message for display further cause the processor to perform steps comprising:
generating the chat message in real time as the message input is received from the sending party.

16. The computer program product of claim 14, wherein the user interface element is located above an input field for inputting the message input within the messaging interface.

17. The computer program product of claim 11, wherein the instructions further cause the processor to perform steps comprising:
identifying an action item associated with the chat message; and
sending the associated action item to the client device to the sending party for display.

18. The computer program product of claim 11, wherein the instructions further cause the processor to perform steps comprising:
obtaining feedback from the sending party that the chat message is selected for transmission to the receiving party;
generating a training example including at least the prompt and the chat message; and
fine-turning parameters of the machine-learned language model using the training example.

19. The computer program product of claim 11, wherein the prompt further specifies contextual information associated with the receiving party or the sending party, and wherein the contextual information includes at least one or a combination of current message history of the conversation, previous instances of conversations between other users, previous instances of conversations between the sending party and the receiving party, and desired language of the receiving party.

20. A computer system comprising:
a processor; and
a non-transitory computer-readable storage medium having instructions that, when executed by the processor, cause the computer system to perform steps comprising:
receiving, from a client device, a message input from a sending party during a conversation with a receiving party within a messaging interface;
generating a prompt for input to a machine-learned language model, the prompt specifying at least the message input and a request to transform the message input to a text string for the receiving party;
providing the prompt to a model serving system for execution by the machine-learned language model;
receiving, from the model serving system, an output generated by executing the machine-learned language model on the prompt, the output comprising the requested text string;
formatting the output as a chat message; and
sending the chat message to the client device of the sending party for display on the messaging interface.
